(19) United States
(12) Patent Application Publication
(10) Pub. No.: US 2012/0215719 A1
(43) Pub. Date: Aug. 23, 2012

(54) Systems and Methods for Creating, Modeling, and Managing Investment Indexes Based Upon Intrinsic Values

(75) Inventor: David Verlander, Atlanta, GA (US)

(73) Assignee: DLV CAPITAL LLC, Atlanta, GA (US)

(21) Appl. No.: 13/399,788

(22) Filed: Feb. 17, 2012

Related U.S. Application Data
(60) Provisional application No. 61/444,407, filed on Feb. 18, 2011.

(51) Int. Cl. G06Q 40/06

(52) U.S. Cl. 705/36 R

(57) ABSTRACT

Methods and systems for determining respective intrinsic values associated with a plurality of entities corresponding to respective securities, wherein the respective intrinsic values are determined based upon estimates relating to future growth or future profitability for each respective entity and further weighting the securities in an investment index, wherein the securities are weighted based at least in part upon the respective intrinsic values.

### CROSS REFERENCE TO RELATED APPLICATIONS

The present application claims priority to U.S. Provisional Application No. 61/444,407, filed Feb. 18, 2011, and entitled SYSTEMS AND METHODS FOR CREATING, MODELING, AND MANAGING INVESTMENT INDEXES BASED UPON INTRINSIC VALUES. The disclosure of the same is hereby incorporated by reference in its entirety.

### FIELD OF THE INVENTION

Embodiments of the present invention relate generally to investment indexes, and more particularly to systems and methods for creating, modeling, and managing investment indexes based upon intrinsic values associated with securities.

### BACKGROUND OF THE INVENTION

Portfolio management strategies fall into two broad categories: active and passive. Active portfolio management entails the buying and selling of securities with the objective of maximizing portfolio return. Passive investing deemphasizes security selection and aims to mirror the performance of the overall market or segment of the market. This can be accomplished by either owning every security in the target market (e.g., in an index) or using statistical modeling to duplicate the risk and performance characteristics of the target benchmark. The advantages of passive investing include: low trading cost due to low portfolio turnover; low management cost because little analysis is required; and the avoidance of potential manager underperformance.

The vast majority of index funds, including the S&P 500 and Wilshire 1000, are capitalization (cap) weighted, which means that each company in the index is weighted by its market capitalization. The popularity of cap-weighted indexing stems from several positive qualities: simple to understand and intuitive because index weights are based on company value; the funds self-balance as prices fluctuate which reduces trading costs; market capitalization is correlated with trading liquidity, which further reduces trading costs; and large investment capacity due to the fund's favorable liquidity characteristics.

However, cap-weighted indexing suffers from several shortcomings. Market capitalization weightings are driven by stock prices, and stock prices often diverge significantly from the underlying company's intrinsic value. When pricing mistakes occur, a market capitalization-weighted index will overweight overvalued companies and underweight undervalued companies. This creates a meaningful drag on fund performance. Also, capitalization-weighted indexes are designed to mirror the market. Consequently the cap-weighted funds fully participate in every market bubble and every market crash. Moreover, a stock's weighting within a cap-weighted index rises and falls with its stock price. Fund managers that want to track the index, explicitly or implicitly, will buy securities with rising prices and sell securities with falling prices. This can exacerbate the volatility of the index and the funds tracking it. Finally, after a popular index announces a company addition to its constituents, arbitragers will drive that stock price higher even before it is added to the index. The opposite occurs when securities are dropped from an index; arbitragers will drive that stock price lower before it is removed from the index. This adds to the performance drag of cap-weighted funds.

A popular alternative to capitalization-weighted indexing is equal-weighted indexing. Equal-weighted indexes reweight the positions of an existing cap-weighted funds by assigning equal weight to each constituent stock. Equal-weighted indexing removes price from the weighting process but introduces other problems. The strategy is prone to high turnover and high trading costs because it mandates equal weights regardless of size and liquidity. Small, illiquid companies must be maintained at the same size as large, liquid companies. Investment capacity is limited for the same reason.

Accordingly, there is an opportunity for systems and methods for passive investment indexes based upon intrinsic values.

### BRIEF DESCRIPTION OF THE FIGURES

Having thus described the invention in general terms, reference will now be made to the accompanying drawing, which is not necessarily drawn to scale, and wherein:

FIG. 1 illustrates an example system for creating, modeling, and/or managing one or more investment indexes, according to an example embodiment of the invention.

FIG. 2 illustrates an example method for creating one or more investment indexes, according to embodiments of the invention.

FIG. 3 illustrates an example method for determining the intrinsic value of an entity, according to embodiments of the invention.

### DETAILED DESCRIPTION

Embodiments of the invention will be described more fully hereinafter with reference to the accompanying drawing, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those of ordinary skill in the art. Like numbers refer to like elements throughout.

Example embodiments of the invention may provide for systems and methods for creating, modeling, and managing investment indexes based upon intrinsic values. In accordance with example embodiments of the invention, these investment indexes may include securities of companies or entities, where the weighting of these securities in the indexes may be based at least in part on an estimated intrinsic value of the companies or entities. It will be appreciated that securities may include stocks; however, securities may also include shares of mutual funds or exchange-traded funds (ETFs) that may include stocks. These stocks may include those traded on virtually any stock exchange, including the NASDAQ and the New York Stock Exchange (NYSE).

In order to provide the investment indexes described herein, the respective intrinsic values of a plurality of securities may be determined. In accordance with an example embodiment of the invention, these intrinsic values may be based upon estimates or expectations of future cash flow, growth, and/or profitability, and not simply intrinsic values calculated solely from past or current accounting metrics items. As an example, these estimates of future intrinsic values may be determined using estimates of future cash flow (e.g., free cash flow) of the companies or entities, as discounted to a present value using a discount rate. As will be discussed in further detail herein, the future cash flow may be obtained, determined, or calculated for a first time period based upon one or more analyst estimates or forecasts relating to growth or profitability, which may include estimates of operating income; net income; revenue; earnings before interest and taxes (EBIT); Operating Profit; earnings before interest, tax, and amortization (EBITDA); Pre-tax Profit; earnings per share (EPS); EPS Fully Diluted; EPS Fully Reported; EBITDA per share; Cash Flow per Share; Long-term Growth; or the like. However, it will be appreciated that these analyst estimates or forecasts, or at least consensus estimates or forecasts, may not be available for a second time period subsequent to the first time period. Analyst estimates can include sell-side analyst consensus estimates, and the like, according to an example embodiment of the invention.

In this case, for a second time period subsequent to the first time period, the future cash flow can be obtained, determined, or calculated (e.g., modeled) by converging analyst estimates or forecasts from the first time period, or values derived therefrom, towards a long-term rate (e.g., discount rate and/or inflation rate) during the second time period. The convergence of analyst estimates or forecasts (relating to growth and/or profitability, which may include operating income, net income, and/or revenue), or values derived therefrom, towards a long-term rate (e.g., discount rate and/or inflation rate) may be based upon the expectation that a company or entity cannot maintain a higher-than-normal growth and/or profitability for an indefinite period of time. For example, technology companies may tend to have quicker growth in early years, but may mature and have slow growth in later years. The discount rate or the inflation rate may be based upon historical values, or may be estimated based upon future expectations, according to an example embodiment.

While the second time period may be referred to as single time period, it may be comprised of multiple time periods, or sub-time periods. For example, during a first sub-time period, the analyst estimates or forecasts from the first time period, or values derived therefrom, can be held constant for a first time period (e.g., X number of years) prior to converging those analyst estimates or forecasts, or values derived therefrom, towards a towards a long-term rate (e.g., discount rate and/or inflation rate) for the remainder of the second time period. As another alternative, the there may be multiple sub-time periods in the second time period where the above-described rates of convergence may be different, according to an example embodiment of the invention.

It will be appreciated that future cash flow for a company or entity may be estimated for a second time period using at least estimates of (1) future growth and (2) profitability. However, in estimating the future cash flow for a company or entity, the economic life of the company or entity may not necessarily be assumed to be infinite, as with conventional methods. Instead, each company or entity may have a defined economic life in accordance with example embodiments of the invention. For example, a company's or entity's economic life may last as long as the company or entity can remain profitable above its discount rate, or cost of equity. For example, if profitability is estimated based upon Return on Equity (ROE) (or alternatively, Return on Capital (ROC)), a company's or entity's economic life for purposes of determining the intrinsic value may last as long as the company's or entity's ROE (or ROC) exceeds its cost of equity (or cost of capital). Indeed, it will be appreciated that a spread between ROE (or ROC) and the cost of equity (cost of capital) may be needed to create or destroy value. As such, once the company's or entity's ROE (or ROC) equals the cost of equity (cost of capital), then additional reinvestment or growth in the company or entity neither adds nor detracts from its intrinsic value, and the terminal value may be its book value or equity.

Accordingly, once the cash flows for the first and second time periods have been determined, as described herein, the intrinsic value of a company or entity can be determined. The intrinsic value of a company or entity may be used to determine a particular weighting of an associated security in an investment index. In an example embodiment of the invention, one or more mutual funds or exchange-traded funds (ETFs) may invest in securities in accordance with the investment index, including the weightings of securities in the index. Many variations of the investment index, including its creation, modeling, and management, will be appreciated by those of ordinary skill in the art.

System Overview

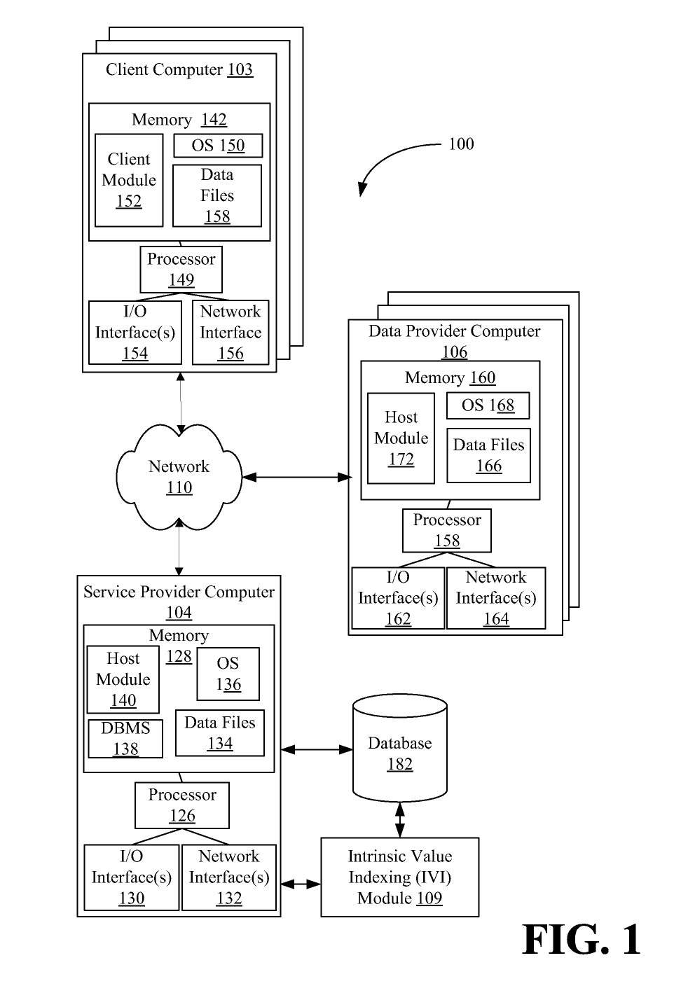

FIG. 1 illustrates an example system 100 for creating, modeling, and/or managing one or more investment indexes, according to an example embodiment of the invention. As shown in FIG. 1, the system 100 may include a client computer 103, a service provider computer 104, and a data provider computer 106, which are each configured for accessing and reading associated computer-readable media having stored thereon data and/or computer-executable instructions for implementing the various methods of the invention. Generally, network devices and systems, including the one or more client computers 103, service provider computers 104, and data provider computers 106 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well-known in the art. As used herein, the term “computer-readable medium” may describe any form of memory or a propagated signal transmission medium. Propagated signals representing data and computer program instructions may be transferred between network devices and systems.

As shown in FIG. 1, the client computer 103, service provider computer 104, and data provider computer 106 may be in communication with each other via a network such as network 110, which as described below can include the Internet or one or more separate or shared private and public networks. Each of these components—the client computer 103, the service provider computer 104, the data provider computer 106, and the network 110—will now be discussed in further detail.

First, the client computer 103 may be any processor-driven device, such as a personal computer, laptop computer, handheld computer, and the like. In addition to having a processor 149, the client computer 103 may further include a memory 142, input/output (“I/O”) interface(s) 154, and a network interface 156. The memory 142 may store data files 158 and various program modules, such as an operating system (“OS”) 150 and a client module 152. The memory 142 may be any computer-readable medium, coupled to the processor 149, such as RAM, ROM, and/or a removable storage device for storing data files 158 and a database management system (“DBMS”) to facilitate management of data files 158 and other data stored in the memory 142 and/or stored in separate databases. The OS 150 may be, but is not limited to, Microsoft Windows®, Apple OSX™, Unix, or a mainframe operating system. The client module 152 may be an Internet browser or other software, including a dedicated program, for interacting with the service provider computer 104. For example, a client of a service provider, such as an investment manager, may utilize the client module 152 to interact with the service provider computer 104 to receive updates to one or more investment indexes, including updated weightings with respect to one or more securities in the one or more investment indexes. As another example, a client may utilize the client module 152 to research or create one or more investment indexes based upon specified criteria. The client module 152 may also be utilized to retrieve or otherwise receive data, messages, or responses from the service provider computer 104.

Still referring to the client computer 103, the I/O interface(s) 154 may facilitate communication between the processor 149 and various I/O devices, such as a keyboard, mouse, printer, microphone, speaker, monitor, bar code readers/scanners, RFID readers, and the like. The network interface 156 may take any of a number of forms, such as a network interface card, a modem, a wireless network card, and the like. It will be appreciated that while client computer 103 has been illustrated as a single computer or processor, the client computer 103 may be comprised of a group of computers or processors, according to an example embodiment of the invention.

The service provider computer 104 may be any processor-driven device that is configured for creating, modeling, and managing investment indexes, according to example embodiments of the invention. Likewise, the service provider computer 104 can also be configured for communication with the client computer 103 and/or data provider computer 106. The service provider computer 104 may include a processor 126, a memory 128, input/output (“I/O”) interface(s) 130, and a network interface 132. The memory 128 may be any computer-readable medium, coupled to the processor 126, such as RAM, ROM, and/or a removable storage device for storing data files 134 and a database management system (“DBMS”) 138 to facilitate management of data files 134 and other data stored in the memory 128 and/or stored in one or more databases 182. The memory 128 may store data files 134 and various program modules, such as an operating system (“OS”) 136, a database management system (“DBMS”) 138, and the host module 140. The OS 136 may be, but is not limited to, Microsoft Windows®, Apple OSX™, Unix, or a mainframe operating system. The host module 140 may receive, process, and respond to requests from the client module 152 of the client computer 103 and/or from the host module 172 of the data provider computer 106.

In addition, a local user of the service provider computer 104 may use the host module 140 to create, model, or manage one or more investment indexes, according to an example embodiment of the invention. To do so, the host module 140 may utilize an intrinsic value indexing (IVI) module 109, which may include computer-executable instructions to support the creating, modeling, or managing of one or more investment indexes, according to an example embodiment of the invention. The IVI module 109 may include at least functionality for receiving data associated with creating, modeling, or managing one or more indexes. Likewise, the IVI module 109 may output data associated with creating, modeling or managing one or more indexes, as described herein.

The service provider computer 104 and/or the IVI module 109 may also include or be in communication with one or more database(s) 182, according to an example embodiment of the invention. The database 182 may store, for example, information or data feeds from one or more data provider computers 106 or client computers 103, or any other information generated as a result of creating, modeling, or managing one or more investment indexes. Although a single database 182 is referred to herein for simplicity, those skilled in the art will appreciate that multiple physical and/or logical databases may be used to store the above mentioned data. For security and performance purposes, the service provider computer 104 may have a dedicated connection to the database 182. However, the service provider computer 104 may also communicate with the database 182 via a network 110, as shown. In other embodiments of the invention, the service provider computer 104 may include the database 182 locally. The service provider computer 104 may also be part of a distributed or redundant DBMS.

The data provider computer 106 may be any processor-driven device, such as, but not limited to, a server computer, a mainframe computer, one or more networked computers, a desktop computer, a personal computer, a laptop computer, a mobile computer, a handheld portable computer, a digital assistant, a personal digital assistant, a digital tablet, an Internet appliance, or any other processor-based device. The data provider computer 106 may include a processor 158, a memory 160, input/output (“I/O”) interface(s) 162, and a network interface 164. The memory 160 may be any computer-readable medium, coupled to the processor 158, such as RAM, ROM, and/or a removable storage device for storing data files 166 and a database management system (“DBMS”) to facilitate management of data files 166 and other data stored in the memory 160 and/or stored in separate databases. The memory 160 may store data files 166 and various program modules, such as an operating system (“OS”) 168, a database management system (“DBMS”), and a host module 172. The OS 168 may be, but is not limited to, Microsoft Windows®, Apple OSX™, Unix, or a mainframe operating system. The host module 172 may receive, process, and respond to requests from the host module 140 of the service provider computer 104. In an example embodiment of the invention, the host module 172 of data provider computer 106 may communicate electronic data feeds to the service provider computer 104 using network 110. As an example, host module 140 may be operated by Capital IQ or another data provider for providing data feeds to the service provider computer 104. As an example, these data feeds can include one or more of the following: a ticker symbol, company names, share price, beta, equity risk premium, or 10-year Treasury rate. Likewise, the data feeds can include financial and/or analyst data. These data feeds can be provided from the data provider computer 106 to the service provider computer 104 (or the client computer 103) on a periodic basis (e.g., daily, twice a day, etc.) or on an as-requested basis.

Still referring to the data provider computer 106, the I/O interface(s) 162 may facilitate communication between the processor 158 and various I/O devices, such as a keyboard, mouse, printer, microphone, speaker, monitor, bar code readers/scanners, RFID readers, and the like. The network interface 164 may take any of a number of forms, such as a network interface card, a modem, a wireless network card, and the like. It will be appreciated that while the data provider computer 106 has been illustrated as a single computer or processor, the data provider computer 106 may be comprised of a group of computers or processors, according to an example embodiment of the invention.

The network 110 may include any telecommunication and/or data network, whether public, private, or a combination thereof, including a local area network, a wide area network, an intranet, an internet, the Internet, intermediate hand-held data transfer devices, a publicly switched telephone network (PSTN), and/or any combination thereof and may be wired and/or wireless.

Generally, each of the memories and data storage devices, such as the memories 142, 128, 160 and the database 182, and/or any other memory and data storage device, can store data and information for subsequent retrieval. In this manner, the system 100 can store various received or collected information in a memory or a database associated with one or more client computers 103, service provider computers 104, and/or data provider computers 106. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices. In one example embodiment, for security, the service provider computer 104 (or any other entity) may have a dedicated connection to the database 182, as shown; though, in other embodiments, the service provider computer 104 or another entity may communicate with the database 182 via a network such as network 110.

Suitable processors, such as the processors 149, 126, 158 of the client computers 103, service provider computers 104, and/or data provider computers 106, respectively, may comprise a microprocessor, an ASIC, and/or a state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript. Furthermore, any of the processors may operate any operating system capable of supporting locally executed applications, client-server based applications, and/or browser or browser-enabled applications.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one example embodiment, the service provider computer 104 (or the client computer 103/data provider computer 106) may be implemented as a specialized processing machine that includes hardware and/or software for performing the methods described herein. Accordingly, embodiments of the invention should not be construed as being limited to any particular operating environment, system architecture, or device configuration.

System Operation

Embodiments of the example system 100 of FIG. 1 may be utilized in creating, modeling, and managing investment indexes based upon intrinsic values. In this regard, example embodiments of the invention may provide for an example indexing method that weights its constituent securities by company/entity value—that is, its intrinsic value, as described herein—while severing price from the weighting equation. For convenience, the example indexing method may be referred to herein as Intrinsic Value Indexing (IVI), and is intended to cover any methodology of creating, modeling, and managing investment indexes using intrinsic values. While specific embodiments may be described herein, it will be appreciated that the methodologies may be applied to other embodiments without departing from example embodiments of the invention.

In an example embodiment of the invention, Intrinsic Value Indexing may be an indexing methodology where securities (e.g., stocks) may be weighted by an estimate of their intrinsic value. Intrinsic Value Indexing uses company value to weight positions, and may provide for one or more of the following features: (i) removing price and human emotion from the weighting process, (ii) removing the value bias inherent in other non-cap-weighting methods, and/or (iii) maintaining the benefits of passive investing and cap-weighting (low turnover and trading costs, low management fees, ease of scalability, easy access to broad diversification), etc.

Overview of Intrinsic Value Indexing

Stock prices vacillate around the intrinsic value of an associated company or entity. When the spread between the stock price and intrinsic value gets too large, position resizing in an index can create alpha (outperformance). Weighting securities in accordance with Intrinsic Value Indexing may be value neutral which allows for more alpha-generating opportunities. Indeed, Intrinsic Value Indexing may be value neutral insofar as the valuation for a company, or industry to which the particular company pertains, may reflect future estimates of growth and profitability. Accordingly, there may be less likelihood of value bias than that which occurs when evaluating a company's value based upon past or current accounting metrics.

As an example, consider Microsoft, or even Walmart, in the mid 1990s. Both companies enjoyed healthy growth prospects and were labeled expensive by conventional indexing measures since the valuations were based primarily on past or current accounting metrics and did not incorporate sufficient growth based upon future outlook. These represent some of the types of opportunities that conventional indexing misses and that Intrinsic Value Indexing may capture. Accordingly, Intrinsic Value Indexing in accordance with an example embodiment of the invention may utilize intrinsic values that are based primarily upon future estimates of free cash flow, growth, and/or profitability.

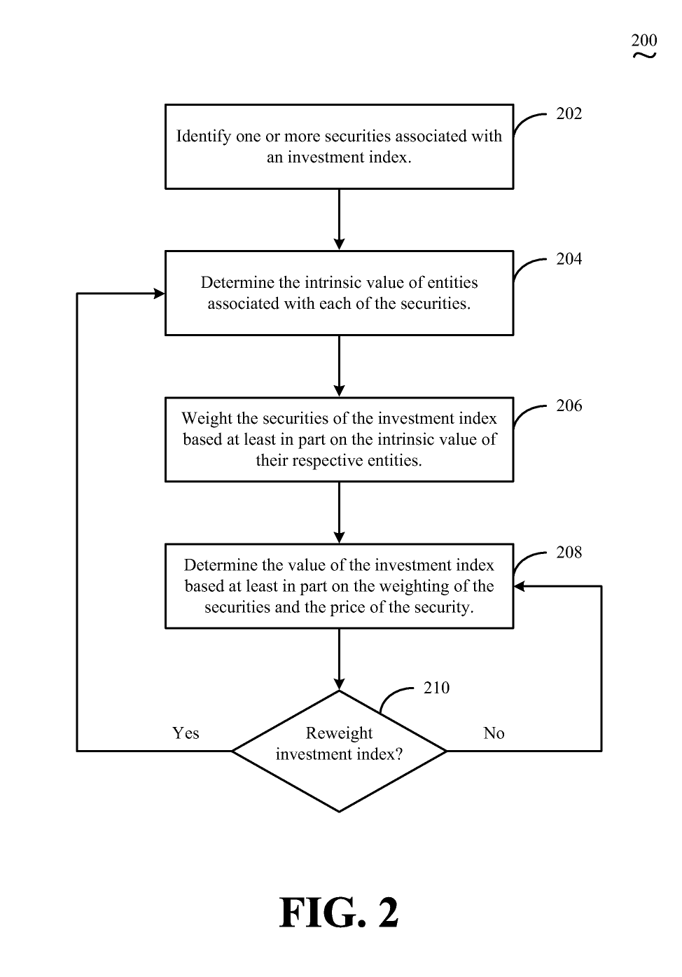

Referring now to FIG. 2, an example method 200 for determining the value of an investment index in accordance with an embodiment of the invention is illustrated. At block 202, one or more securities associated with an investment index may be identified. The identification of the securities may be performed by the service provider computer 104 or the IVI module 109. In one aspect, the securities of the investment index may be identified by a user of the investment index, such as an end user, an investor, a portfolio manager, a hedge fund manager, or the like. In such a scenario, the end user of the investment index may instruct the service provider computer 104 on which securities to include in the investment index by, for example user input. In other aspects, the securities of the investment index may be identified based on a particular industry group or region. As a non-limiting example, a particular investment index may include companies exceeding a predetermined market capitalization or intrinsic value in the medical products industry. As another non-limiting example, a particular investment index may include securities listed on the NYSE that exceed a predetermined market capitalization.

At block 204, the intrinsic values of entities associated with the securities are determined. In this case, when the securities to be included in the investment index are identified, the underlying entities, such as companies, corporations, master limited partnerships, real estate investment trusts, and the like along with associated financial data, projections, and estimates may be analyzed by the IVI module 109 to determine the intrinsic value of the underlying entity.

In accordance with example embodiments of the invention, IVI may utilize a variety of methods for modeling the intrinsic value of a company or entity. As an example, the intrinsic value may be based upon one or more discounted cash flow (DCF) models. In general, a DCF model may be based on a notion that a value of a company is equal to the present value of its future cash flows. It will be appreciated that many variations of DCF models are available, including any of the following cash flow models:
Free Cash Flow to Equity;
Firm Valuation: Value of equity may be determined by valuing the entire company/entity and subtracting debt;
Residual Income: Equity is added to the present value of residual income (the amount which profits exceed the required rate of return on equity);
Economic Value Added (EVA);
Cash Flow Return On Investment (CFROI); and/or
Economic Margin.

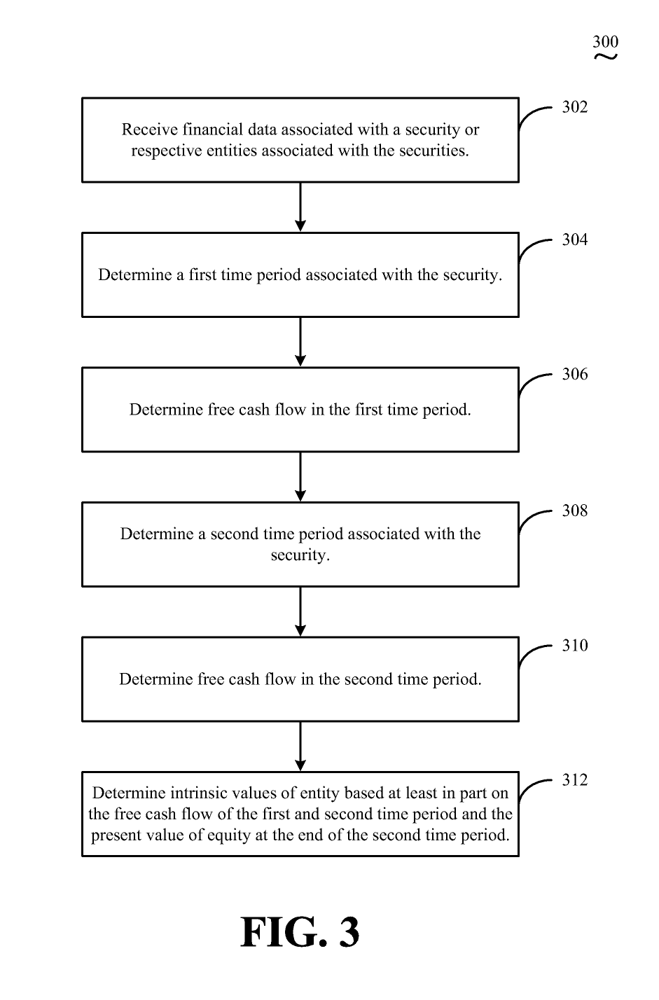

It will be appreciated that while embodiments of the invention may calculate intrinsic values based upon an example discounted cash flow (DCF) model, other cash flow models may be similarly utilized without departing from example embodiments of the invention. It will be appreciated that the discounted cash flow model in accordance with example embodiments may include any of the following attributes: (i) scalable for evaluating any number of publicly traded companies; (ii) entirely formulaic to remove natural human biases and facilitate consistency; and/or (iii) intuitive and logical to promote accuracy and ensure objectivity. However, many other attributes of a discounted cash flow model may be available as well. Details of determining the intrinsic value of an entity in accordance with embodiments of the invention will be disclosed further with reference to FIG. 3 below.

At block 206, the securities of the investment index may be weighted, at least in part, based on the intrinsic value of the respective underlying entities as determined at block 204 for each of the securities. The weight of each security of the investment index may be determined, in certain embodiments, by the IVI module 109 based on the intrinsic value of the entities corresponding to the securities. In other embodiments, the weight of each security based upon the intrinsic value of the underlying entities may be determined by the service provider computer 104.

In one aspect, the weight of each security may be proportional to its intrinsic value. In a further aspect the weight of each security may be determined as a ratio of the corresponding entities intrinsic value divided by the sum of the intrinsic values of all of the corresponding entities associated with all of the securities that are constituents of the investment index. Therefore, a calculation of the intrinsic value weighting coefficient for each security may be performed and may be a function of the intrinsic value of that company or entity and the intrinsic values for all companies and entities in the investment index. As a non-limiting example, the weight coefficient, Cᵢ, for each security in the index, may be calculated based upon the intrinsic value of the company as a percentage of the total intrinsic value of all of the companies within the index. In equation format:

$${C}_{i} = \frac{{IV}_{i}}{{\sum }_{k = 1}^{n} {IV}_{k}} \qquad ( Equation 1 )$$

where,
Cᵢ is the weight coefficient of the i^{th} security.
IVₖ is the intrinsic value of the k^{th} entity, corresponding to the k^{th} entity.
IVᵢ is the intrinsic value of the i^{th} entity, corresponding to the i^{th} security.
n is the total number of securities in the investment index.

In the foregoing non-limiting example, it should be noted that the intrinsic value coefficient may be calculated such that the weighting of the individual securities may be proportional to the respective entity's intrinsic value. It will be appreciated that many variations of calculating the weighted coefficients are available. Indeed, the weighting coefficients may be adjusted for one or more securities without departing from example embodiments of the invention. For example, in certain embodiments, the weighting coefficient may be based on both the intrinsic value of the underlying security, as well as, the price of the security. In other words, the weighting coefficient may be normalized to the value of the shares of the security. Put in yet another way, the weighting coefficient may be proportional to the value of a particular security in the investment index, rather than shares of the security in the investment index.

At block 208, the value of the investment index may be determined based at least in part on the weighting of each of the securities and the price of the security. In one aspect, the value of the investment index may be determined by the IVI module 109 or the service provider computer 104. With the calculated intrinsic value weighted coefficients, Cᵢ, for each security, the coefficient may be applied to each respective security to determine the amount of the security in the investment index. In certain embodiments, the number of shares of each of the securities may be proportional to the calculated weighting coefficient. As a non-limiting example of this embodiment, the index value may be calculated as follows:

$$V = {\sum }_{k = 1}^{n} {C}_{k} \times {SP}_{k} \qquad ( Equation 2 )$$

where,
V is the value or price of the investment index.
Cₖ is the weight coefficient of the k^{th} security.
SPₖ is the security price of the k^{th} security.
n is the total number of securities in the investment index.

In other embodiments, the calculated value or price of the investment index may be normalized by a fixed and predetermined multiplier. In certain other embodiments, the quantity of the security purchased in the investment index may be normalized by the price of the security. It will be appreciated that there may be a variety of linear and non-linear mechanisms and mathematical functions that may describe the allocation of funds to each of the securities of the investment index.

It should further be appreciated that if the intrinsic value of a particular security can not be determined or can not be determined with a predetermined confidence level, then other mechanisms of allocating a weight coefficient to that particular security may be employed. In certain embodiments, securities for which the intrinsic value of the underlying entity can not be determined, may not be included in the investment index. For example, the weight coefficient of one or more securities in a particular investment index may be determined based on the market capitalization or book value of the underlying entity, rather than the intrinsic value of the underlying entity.

In block 210, it is determined if the investment index should be reweighted. In certain embodiments, determining the weighting and individual weight coefficients of individual constituent securities of the investment index may be performed at predetermined times, such as, annually, quarterly, monthly, daily, or the like. In one aspect, the predetermined time of recalculating the weighting of securities in the investment index may be selected so that reweighting is not too frequent, but also captures the true intrinsic value at any particular point in time of each of the securities and associated entities within the investment index. In another aspect, the reweighting of securities within the investment index may be performed at times when there is relatively less volatility in the determination of the intrinsic value of individual securities within the investment index. In certain other embodiments, the determination of whether the investment index should be reweighted may be provided by the user of the investment index via, for example the service provider computer 104 or the client computer 103. Any variety of mechanisms for determining when the investment index and the securities therein are reweighted are envisioned in embodiments of the invention.

It will be appreciated that a particular index, or emulation thereof, may be reweighted by one end user at a particular frequency and by another end user at a different frequency. For example, a particular portfolio manager may run an index fund and try to match a particular index and perform a daily reweighting of the constituent securities of the investment fun. Another investment manager may try to emulate the same index and perform reweighting on a weekly basis. One may select the reweighting frequency based on a variety of factors such as the amount of deviation from a real time reweighting that may be tolerated by an end user or by other factors such as portfolio transaction and trading costs associated with tracking an investment index.

At block 210, if it is determined by a variety of mechanisms that the investment index and the securities therein are ready to be reweighted, then the method 200 may return to block 204 to recalculate the intrinsic value of each of the securities within the investment index. If however, at block 210, it is determined that reweighting is not necessary at that time, then the method 200 may return to block 208 to recalculate the price of the investment index. In one aspect, the recalculation of the price of the investment index at block 208 may be performed at a relatively higher frequency than determining the weighting of each of the constituent securities of the investment index at block 204.

It should be noted, that the method 200 may be modified in various ways in accordance with certain embodiments of the invention. For example, one or more operations of method 200 may be eliminated or executed out of order in other embodiments of the invention. Additionally, other operations may be added to method 200 in accordance with other embodiments of the invention. For example, in certain embodiments, the method 200 may have additional functionality associated therewith related to automated ticket or order generation. If a portfolio rebalancing is needed based on recalculated weighting and associated weight coefficients of each of the securities of the investment index at block 206, then the service provider computer 204 may automatically generate a trade execution order ticket based thereon. In other words, trades including sell orders to reduce the weight of a particular security and buy orders to increase the weight of another security may be automatically generated to effect a weighted allocation according to calculated weight coefficients at block 206 in accordance with embodiments of the invention. In one aspect, the order tickets may be generated and may require user approval for execution. In another aspect, the order tickets may be transmitted to a broker or dealer for execution. In a further embodiment, orders may automatically be executed when reweighting of securities, or a recalculation of the weight coefficient is performed for the securities of a particular investment index. In yet a further embodiment, the service provider computer 104 may wait for a change in the weight that is greater than a predetermined amount for securities in a particular investment index before generating order tickets or executing orders. In such embodiments, the level of trading may be minimized when there is a relatively small change in the weight of particular securities of an investment index from one weight coefficient calculation period to the next.

It will also be appreciated that, in certain embodiments, the securities included in a particular investment index may not be fixed. For example, the inclusion of a particular security in an investment index may depend on the intrinsic value of the entity associated with that security. For example, a particular investment index may only include securities with associated entities that exceed a particular intrinsic value or is within a range of intrinsic values. In these embodiments, at block 202, intrinsic values of entities may be considered before selecting a subset of those entities for inclusion in the investment index.

In certain example embodiments of the invention, the IVI module 109 can support the creating, modeling, or managing of one or more investment indexes by determining the intrinsic values of one or more companies or entities. To do so, the IVI module 109 can support one or more of the following features:
Receive financial data inputs, one or more of which may be utilized for determining intrinsic values in accordance with an example cash flow model:
   Financial Data
      Ticker symbol (e.g., IBM, AAPL, etc.)
      Company/entity name
      Per share price
      Beta
      Equity risk premium
      10-year Treasury rate or other bond rate
      Financial statement data (e.g., income statement, balance sheet statement, cash flow statement, notes to financial statements, etc.)
   Analyst estimate data
      Profitability
         Operating income
         Net income
         Earnings before interest and taxes (EBIT)
         Operating Profit
         Earnings before interest, tax, and amortization (EBITDA)
         Pre-tax Profit
         Earnings per share (EPS)
         EPS Fully Diluted
         EPS Fully Reported
         EBITDA per share
         Cash Flow per Share
      Growth
         Net income
         Revenue
         Long-term Growth
Configure DCF model to specify convergence criteria, including growth and profitability (e.g., ROE, ROC) progression over the life of the company or entity
Execute DCF model using financial data, analyst estimate date, and convergence criteria to determine cash flows for one or more time periods for a company or entity
Determine intrinsic values for a company or entity based upon determined cash flows for one or more time periods
Specify, modify, or adjust weightings of a security in an index based upon determining the associated intrinsic values.

From FIG. 2, it can be seen that the method for allocation amongst constituent securities of the investment index relies on a determination of the intrinsic value, as in block 204, of each of the securities. Any variety of methods for determining intrinsic value may be used for for the purposes of determining the weight of each security within the investment index. It will, however, be appreciated that an example DCF model in accordance with an example embodiment of the invention may be distinctly different from conventional DCF models. In particular, conventional DCF models forecast free cash flow (FCF) out for five to ten years, and then calculate a terminal value. However, the terminal value is simply a crude heuristic that implicitly assumes that the company's profitability and growth leading into the terminal value will last forever. In addition, the terminal value in the conventional DCF model typically makes up 50-90% of a company's value. In short, conventional discounted cash flow models introduce errors into intrinsic valuations by assuming that a company's profitability and growth has an infinite economic life when determining a terminal value.

By contrast, an example DCF model or other cash flow model in accordance with an example embodiment of the invention may not assume that a company or entity has an infinite economic life nor can achieve a rate of growth above the rate of inflation indefinitely. Indeed, in accordance with the example DCF model or other cash flow model, no company or entity may be expected to create value above and beyond a discount rate and/or achieve a rate of growth above the rate of inflation for an indefinite amount of time. Instead, each company or entity may have a defined economic life and growth may be converged to inflation in a finite number of years. For example, companies in certain sectors (e.g., technology) may be associated with a first defined economic life while companies in other sectors (e.g., commodities) may have a second defined economic life different from the first defined economic life. A defined economic life of a company or entity may be a period in which the company or entity can create value (e.g., remain profitable) above and beyond a discount rate. For example, for an example DCF model, a company's economic life can last as long as the company's ROE or other measure of profitability is above (or below) its Discount Rate. Indeed, a spread between ROE or other measure of profitability and the cost of equity may be required for value creation (or destruction). Once these two metrics converge, which occurs over time in all example DCF models or other cash flow models, the company's economic life ends and additional reinvestment or growth in the company neither adds nor detracts from its intrinsic value, and the terminal value may equal the book value or equity available at the end of the its economic life. In an alternative embodiment of the invention, if a Residual Income model is being used instead of an example DCF model, economic profits would equal zero from this point forward (e.g., at the end of the company's economic life).

Discounted Cash Flow (DCF) Model for Calculating Intrinsic Value

As described herein with respect to FIG. 1, an example intrinsic value indexing (IVI) module 109 may include computer-executable instructions to support the creating, modeling, or managing of one or more investment indexes, according to an example embodiment of the invention. The IVI module 109 may utilize an example DCF model or other similar model for purposes of calculating cash flows used in determining intrinsic values for one or more companies or entities corresponding to respective securities. It will be appreciated that the IVI module 109 may use the example DCF model for determining intrinsic values for virtually any company or entity for which certain measures of growth and/or profitability are available. For example, these companies or entities may be associated with securities that trade on a stock exchange such as the New York Stock Exchange and the NASDAQ Stock market. Once the intrinsic values of the companies or entities are determined, they may be ranked, analyzed, or considered by the IVI module 109 for inclusion in one or more investment indexes. For example, an investment index may include shares of the largest 500 companies or entities, where the shares may be weighted by the calculated intrinsic values. Likewise, intrinsic values of companies or entities may be calculated for purposes of rebalancing the weightings of one or more securities in an investment index by the IVI module 109.

It will be appreciated that the IVI module 109 may be part of the service provider computer 104 or virtually any other computer such as a computer programmed to perform one or more steps or processes described herein. The IVI module 109 may include one or more software programs, whether specifically programmed software or off-the-shelf software (e.g., Excel, MATLAB, etc.), for performing certain calculations in accordance with example DCF or cash flow models. Many variations of the example software programs are available without departing from example embodiments of the invention.

Referring now to FIG. 3, and example method 300 is disclosed for determining the intrinsic value of an entity in accordance with embodiments of the invention. At block 302, financial data associated with a security or associated entity may be received. In particular, the IVI module 109 may receive financial data from one or more data provider computers 106 or databases 182. For example, financial data may be received from a Capital IQ database or any other financial data source (e.g., Tradestation, financial service providers, etc.), according to an example embodiment of the invention. The received financial data may include pricing data for one or more securities, as well as information obtained from a company's or entity's income statements, balance sheet statements, cash flow statements, statement of equity, and notes to financial statements, which may, for example, be available from SEC filings. In addition, the received financial data can include analyst estimate data (e.g., Thomson Reuters I/B/E/S Estimates or other sell-side consensus estimates) for future net income and/or growth for one or more companies or entities, according to an example embodiment of the invention. In addition, IVI module 109 may determine or receive financial data that includes the expected equity risk premium. For example, the expected equity risk premium (e.g., 3.5% or another value) can be obtained based upon historical analysis or otherwise supplied from a data source. Other financial data that can be determined or received includes a company's or entity's two-year beta (e.g., measure of systematic risk obtained from and calculated by Capital IQ), and the long-term average 10-year Treasury yield (e.g., 4.75% or another value).

At block 304, a first time period associated with the security or associated entity may be determined. In one aspect, this time period may be determined based on the availability of financial estimates and projections. For example, the first time period may be characterized by having available analyst estimates of certain financial information, such as revenue, profits, cash flow, margins, or the like. In certain embodiments, the first time period may be characterized by the availability of relatively reliable projections or estimates of certain financial information.

Next, at block 306, free cash flow in the first time period may be determined. The IVI module 109 can determine or calculate the intrinsic value of a company or entity based upon its expected free cash flows discounted back at a rate that reflects the riskiness of those cash flows. Accordingly, intrinsic value may be derived from free cash flows determined from an example DCF model and a discount rate. Likewise, free cash flow may be determined or derived by the DCF model based upon growth and profitability, according to an example embodiment of the invention. It will be appreciated that profitability in an example DCF model may refer to how profitably a company or entity can employ its equity, or return on equity (ROE). On the other hand, when using a Firm Valuation cash flow model or the Residual Income cash flow model, profitability may refer to how profitably a company can deploy its capital, or return on capital (ROC), according to an alternative embodiment of the invention.

Accordingly, intrinsic value may be a function of Growth, Profitability and Discount Rate. Table I below illustrates this relationship and lays out the basic framework for an example DCF model. The DCF model's inputs and outputs vary depending on the availability of analyst forecast data, as discussed in further detail below.

TABLE I

| | Year | | | |
|---|---|---|---|---|
| | 0 | 1 | 2 | 3 |
| Revenue | 400.0 | 440.0 | 480.0 | 525.0 |
| Net income* | | 20.0 | 22.0 | 24.0 |
| Equity Allocation (change in Equity) | | −8.8 | −12.0 | −13.5 |
| Free Cash Flow | | 11.2 | 10.0 | 10.5 |
| Assets* | 150.0 | 164.8 | 179.8 | 196.6 |
| Assets - Average | | 157.4 | 172.3 | 188.2 |
| Equity* | 123.0 | 131.8 | 143.8 | 157.3 |
| Equity - Average | | 127.4 | 137.8 | 150.6 |
| ROE* | | 15.7% | 16.0% | 15.9% |
| Discount Rate* | | 8.7% | 8.7% | 8.7% |
| Growth | | 10.0% | 9.1% | 9.4% |
| Turnover (revenue/avg assets) | | 2.67 | 2.67 | 2.67 |
| Leverage (equity/assets) | | 80.0% | 80.0% | 80.0% |

Remember, our goals within the DCF model may be twofold: First, we need to model free cash flow because free cash flow is what is ultimately present valued to calculate intrinsic value. Second, we need to monitor and manage the spread between Profitability and Discount Rate because this ultimately determines the economic life of the company.

During the first time period, the model may be driven by analyst estimates. For example, these analyst estimates can be for revenue and net income, although other estimates of growth or profitability can be utilized as well. During this first period, revenue and net income may be an input to the DCF model. Assets and equity balances may be calculated by using revenue and the turnover and leverage ratios (initial turnover may equal the historical five-year average and may be held constant for the company's entire economic life and the initial leverage ratio may equal the historical two-year average and may be held constant for the company's entire economic life). Assets may be calculated as revenue/turnover. Equity may be calculated as assets*leverage. Free cash flow may be calculated as net income−equity allocation (change in year/year equity balances). Consensus analyst estimates may be used for as many years as estimates are available, where the consensus estimates may comprise at least a predetermined number (e.g., 2, 3, 4, etc.) of individual estimates to be used in the analysis. Accordingly, free cash flow can be determined based upon these analyst estimates for the first time period.

It will be appreciated that in the determination of free cash flow in the first time period, certain analyst estimates may be filtered based on a variety of factors. For example, outlier analyst estimates may be filtered out before using the same for determining free cash flow in the first time period. As another example, relatively unreliable analysts and their resulting estimates may be filtered out of the collection of analyst estimate data before using the same for the purposes of determining cash flow in the first time period. In this example, analyst performance data may be stored in database 182 or acquired via the network 110 by one or both of the service provider computer 104 or the IVI module 109 to filter analyst estimate data according to predetermined criteria and thresholds. In yet another example, analyst estimate data may be weighted according to historical performance of the analysts providing the estimates. Indeed, there may be a variety of alternate mechanism by which to filter or weight or generally ascertain the quality of analyst estimates. An exhaustive list of the same will not be covered here in the interest of brevity.

At block 308, the method 300 may determine a second time period associated with the security. The second time period may be characterized by a time when analyst estimates of financial data are not available. Consider a non-limiting example where financial analysts, for a particular security, may provide estimates of the associated entity for three years in to the future. In this example, the first time period may extend to three years and the second time period may start beyond three years. As a result the first and second time periods may be non-overlapping. In certain other embodiments, the demarcation between the first time period and the second time period may be determined based on the availability of reliable or complete analyst estimates of financial data, and not merely availability of estimates. The second time period may extend until the end of the economic life of the entity.

It will be appreciated that the demarcation between the first time period and the second time period may change over time. For example, as more analyst estimates become available further in the future, the first time period may likewise progress further in to the future. Accordingly, the second time period may start at a later time, such as at the end of the first time period. Furthermore, the determination of the end of the economic life of an entity may change with additional analyst estimates and, therefore, the end of the second time period may further progress forward in time.

At block 310, the cash flow during the second time period may be determined. Once analyst estimates are no longer available, the DCF model may then model free cash flow for the second time period subsequent to the first time period. In this regard, Profitability (e.g., ROE) and Growth may be inputs to the DCF model that are explicitly modeled, and all other items from Table I may be outputs that are calculated. Revenue may be calculated as the previous year's revenue×(1+Growth). Equity may be calculated as turnover/leverage. Net income may be calculated as Profitability×average equity. Free cash flow may be calculated as net income−equity allocation.

It will be appreciated that in the second time period, Growth may be converged to a long-term normalized rate of inflation while Profitability (e.g., ROE) may be converged to the Discount Rate. Once Profitability (e.g., ROE) converges with the Discount Rate, the economic life of the company ends (as well as the final time period), and the equity balance may be the only remaining value.

While the second time period may be referred to as single time period, in certain embodiments, it may be comprised of multiple time periods, or sub-time periods. For example, during a first sub-time period, the analyst estimates or forecasts from the first time period, or values derived therefrom, can be held constant for a first time period (e.g., X number of years) prior to converging those analyst estimates or forecasts, or values derived therefrom, towards a towards a long-term rate (e.g., discount rate and/or inflation rate) for the remainder of the second time period. As another alternative, the there may be multiple sub-time periods in the second time period where the above-described rates of convergence may be different, according to an example embodiment of the invention.

It will be appreciated that the IVI module 109 may calculate intrinsic value for a company or entity as a sum of the present value of free cash flow (for both the first and second time periods) and present value of equity at the end of the economic life at block 312. Next, if applicable, in certain embodiments, intrinsic value may be adjusted by adding back excess cash and making adjustments for an overfunded pension assets or underfunded pension liabilities.

It will also be appreciated that each company may have a unique Profitability (e.g., ROE) and Growth progression profile. The early trajectory of Profitability (ROE) and Growth, and the rate at which Profitability (ROE) is converged to the Discount Rate and Growth is converged to inflation, may be a function of many factors, which may include one or more of the following: historical profitability level, historical profitability volatility, recent profitability trend, stock beta, company industry classification, total invested capital, leverage, historical growth level and recent growth trend. For example, a company with a high level of profitability may attract more competition and be more susceptible to profitability erosion than a company with a low level of profitability. As another example, a company with a high level of total invested capital may be more entrenched and less susceptible to competition than a company with a low level of total invested capital. Likewise, a technology company may have a product or service offering that is more susceptible to obsolescence than a durable goods company and therefore have a faster rate of Profitability and Growth degradation. Consider, for example, two companies: Company ABC being a technology company with an ROE of 60% and Company XYZ being a consumer goods company with an ROE of 15%. Company ABC's ROE may be eroded by 50% to 30% after eight years while company XYZ's ROE may be eroded by 10% to 13.5% over the same time period. It will be appreciated that many variations in time periods for convergence may be available without departing from example embodiments of the invention. While ROE may be converged to the Discount Rate and Growth may be converged to inflation, these two events may not necessarily occur in the same time period. For example, Company ABC's ROE may converge to its Discount Rate in year 20, while Company ABC's Growth may converge to inflation in year 10. The economic life of a company may end when ROE is converged to the Discount Rate. And while growth neither adds nor detracts from value once ROE is converged to the Discount Rate, Growth can converge to inflation before the economic life of a company ends, according to an example embodiment of the invention. In some instances where an intrinsic value could not be calculated due to insufficient data, a company's market capitalization can be used for weighting purposes.

It will be appreciated that the valuation analysis by the IVI module 109 could have been conducted using a different cash flow model without departing from example embodiments of the invention. For example, if the Firm Valuation cash flow model were utilized instead of the DCF model, equity may be replaced with invested capital, Profitability may change from ROE to ROC (return on capital), net operating profit after taxes (NOPAT) may be used instead of net income, and the weighted average cost of capital (cost of debt and equity) may be used instead of cost of equity. Once firm value is determined, all non-equity claims may be deducted to arrive at an estimated value for equity.

As yet another example, the Residual Income or Excess Return model may be utilized instead of the DCF model. In this alternative, value=today's equity value plus the present value of annual residual income (the amount which net income exceeds Discount Rate×beginning period equity). All of the adjustments made in the Firm Valuation model can also be made here and achieve a Firm version of the Excess Return model. Other versions of the Residual Income Model include Economic Value Added (EVA), Cash Flow Return on Investment (CFROI) and Economic Margin.

In accordance with an example embodiment of the invention, the IVI module 109 may weight each company or entity in the index by its intrinsic value. The index may be reconstituted or rebalanced on the first trading day of each calendar year based on intrinsic values that were calculated using data available on the last trading day of the previous year. Other schedules for reconstituting or rebalancing the index may be available without departing from example embodiments of the invention.

### Example Formulas and Definitions

Assets=core assets=cash required+accounts receivable+inventory+net property plant and equipment

Cash required (cash required to run the business)=The lowest annual cash/revenue ratio over the past five years×revenue

Equity=core equity=core assets−core liabilities (current liabilities+long-term debt)

Leverage=core equity/core assets

ROE=net income (excluding nonrecurring gains and losses)/average core equity

Discount Rate=long-term ten year Treasury rate (4.75%)×(two-year beta×equity risk premium (3.5%). Based on the Capital Asset Pricing Model (CAPM)

Equity allocation=core equity at the beginning of the year (or end of previous year)−core equity at the end of year

Net income=Net income excluding nonrecurring gains and losses+adjustments for deferred taxes−unrecognized stock options expense+certain goodwill and other intangibles amortization

Many modifications and other embodiments of the invention set forth herein will be apparent having the benefit of the teachings presented in the foregoing descriptions and the associated drawing. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

That which is claimed:

1. A method, comprising:
determining, by one or more computers comprising one or more processors, respective intrinsic values associated with a plurality of entities corresponding to respective securities, wherein the respective intrinsic values are determined based at least in part upon estimates relating to one or both of future growth and future profitability for each respective entity; and
weighting, by the one or more computers, the securities in an investment index, wherein the securities are weighted based at least in part upon the respective intrinsic values.

2. The method of claim 1, further comprising identifying, by the one or more computers, the plurality of entities corresponding to respective securities.

3. The method of claim 2, wherein identifying the plurality of entities corresponding to respective securities comprises selecting a subset of entities from a larger set of entities based at least in part on the intrinsic values of each of the entities in the larger set.

4. The method of claim 1, further comprising determining, by the one or more computers, a value of the investment index based at least in part on the weighting of the securities and price of the securities.

5. The method of claim 1, further comprising determining, by the one or more computers, second respective intrinsic values associated with the plurality of entities corresponding to respective securities at a second point in time after a time interval following the determining of the respective intrinsic values.

6. The method of claim 6, wherein the time interval is at least one of: (i) hourly; (ii) daily; (iii) weekly; (iv) bi-weekly; (v) monthly; (vi) bi-monthly; (vii) quarterly; (viii) bi-annually; or (ix) annually.

7. The method of claim 1, wherein determining the respective intrinsic values associated with the plurality of entities further comprises determining, by the one or more computers, a respective first time period and a respective second time period for each of the plurality of entities.

8. The method of claim 7, wherein determining the respective intrinsic values associated with the plurality of entities further comprises determining, by the one or more computers, a respective free cash flow in the first time period and a free cash flow for the second time period.

9. The method of claim 1, wherein determining the respective intrinsic values associated with the plurality of entities further comprises determining, by the one or more computers, a present value of equity at the end of the second time period.

10. A system for managing investment indexes, comprising:
at least one memory for storing computer-executable instructions;
at least one processor in communication with the at least one memory, wherein the at least one processor is configured to execute the computer-executable instructions to:
identify one of a plurality of securities;
determine one or more first cash flows for a first time period, wherein the cash flow is determined based upon one or more analyst estimates or forecasts associated with growth and profitability of an entity associated with the security for the first time period;
determine one or more second cash flows for a second time period subsequent to the first time period, wherein the one or more second cash flows are determined based at least in part on converging at least one of the one or more analyst estimates or forecasts from the first time period, or values derived therefrom, towards one or more long-term rates; and
estimate an intrinsic value of an entity associated with the security based by combining the one or more first cash flows and the one or more second cash flows.

11. The system of claim 10, wherein the converging includes (i) converging a measure of growth available at an end of the first time period towards a rate of inflation during the second time period, and (ii) converging a measure of profitability available at an end of the first time period towards a discount rate during the second time period.

12. The system of claim 11, wherein the measure of growth is revenue or net income, and wherein the measure of profitability is return on equity (ROE) or return on capital (ROC).

13. The system of claim 10, wherein the analyst estimates associated with growth and profitability include one or more of estimates for: operating income; net income; revenue; earnings before interest and taxes (EBIT); Operating Profit; earnings before interest, tax, and amortization (EBITDA); Pre-tax Profit; earnings per share (EPS); EPS Fully Diluted; EPS Fully Reported; EBITDA per share; Cash Flow per Share; or Long-term Growth.

14. The system of claim 10, wherein the second time period comprises a plurality of sub-time periods, wherein a rate of convergence differs for at least two of the plurality of sub-time periods.

15. The system of claim 14, wherein the rate of convergence for a first sub-time period is zero, wherein a zero rate of convergence results in one or more estimates associated with growth or profitability being held constant during the first sub-time period.

16. The system of claim 10, wherein the at least one processor is further configured to execute the computer-executable instructions to:
determine or adjust a weighting of the identified security in an index based at least in part upon the estimated intrinsic value of the entity associated with the identified security.

17. The system of claim 10, wherein the index includes the plurality of securities, wherein the index is tracked by a mutual fund or an exchange-traded fund (ETF) that holds the securities, and wherein the mutual fund or ETF buys or sells shares of the identified security based upon the determined or adjusted weight of the identified security.

18. The system of claim 10, wherein the one or more analyst estimates of growth include one or more estimates associated with the revenue of the entity associated with the security.

19. The system of claim 10, wherein profitability is associated with Return on Equity (ROE) or Return on Capital (ROC).
